(19) United States
(12) Patent Application Publication
(10) Pub. No.: US 2025/0185714 A1
(43) Pub. Date: Jun. 12, 2025

(54) Heating Apparatus for an Aerosol Generating Device

(71) Applicant: JT International SA, Geneva (CH)

(72) Inventor: René Van De Meeberg, Zwolle (NL)

(73) Assignee: JT International SA, Geneva (CH)

(21) Appl. No.: 18/846,128

(22) PCT Filed: Mar. 17, 2023
(86) PCT No.: PCT/EP2023/056888

§ 371 Date: Sep. 11, 2024

(30) Foreign Application Priority Data
Mar. 17, 2022 (EP) 22162826.6

(51) Int. Cl. A24F 40/46; A24F 40/50; H05B 3/04

(52) U.S. Cl. CPC A24F 40/46; A24F 40/50; H05B 3/04

(57) ABSTRACT

A heating apparatus for an aerosol generating device includes: an inner wall defining a heating zone and an opening through which an aerosol forming substance can be received in the heating zone; a heater arranged on the inner wall and configured to provide heat to an aerosol forming substance that is received in the heating zone; an outer wall positioned radially outwardly with respect to the inner wall; and a glass connecting portion connecting the inner wall and the outer wall.

### FIELD OF THE INVENTION

The present invention relates to a heating apparatus for an aerosol generating device and an aerosol generating device comprising a heating apparatus. The disclosure is particularly applicable to a portable aerosol generating device, which may be self-contained. In particular, the invention relates to an aerosol generating device with a heater disposed within a vacuum or insulator chamber.

### BACKGROUND

It is a developing field of interest to produce electronic cigarettes that heat, but do not burn, a solid or semi-solid aerosol forming substrate which comprises tobacco. These devices typically receive a rod of tobacco in a heating chamber. The rod is heated to release aerosol which can be inhaled by a user. One issue in these devices is that the heater which supplies heat to the heating chamber can also undesirably heat the remainder of the device. In compact devices this can be disadvantageous because the temperature of the outer surfaces of the device, which are held by a user, can become unacceptably high. In order to mitigate these effects some aerosol generating devices have been provided with vacuum chambers that can space the heater from the outer surfaces. This can provide thermal separation between the heating chamber and the outer surfaces which are held by a user.

Within such aerosol generating devices, it is desirable to improve the efficiency of the heating operation such that the battery life of the device may be extended. To this end, vacuum insulators have been implemented within aerosol generating devices in order to thermally insulate the cavity in which an aerosol substrate is heated, thereby limiting thermal losses to the external environment.

An object of the present invention is to further improve the heating efficiency and reduce undesired heat loss.

### SUMMARY OF INVENTION

According to an aspect of the invention, there is provided a heating apparatus for an aerosol generating device, comprising: an inner wall defining a heating zone and an opening through which an aerosol forming substance can be received in the heating zone; a heater arranged on the inner wall and configured to provide heat to an aerosol forming substance that is received in the heating zone; an outer wall positioned radially outwardly with respect to the inner wall; and a glass connecting portion connecting the inner wall and the outer wall.

In this way, the heating zone is insulated by an insulating space provided between the inner wall and the outer wall (connected by the glass connecting portion), where the glass connecting portion can effectively prevent heat loss from the heating zone by preventing conduction of thermal energy created by the heater from the inner wall to the outer wall. The inner and outer walls form a dual-walled insulator between which the insulating space or insulation space is provided. It has been found that there are no heating apparatuses in the art according to the invention, which uses a glass connecting portion between the inner and outer walls. Common non-metallic materials for constructing an enclosure in known aerosol generating devices are plastics, for its easy manufacturability and non-magnetic properties. As will be appreciated, a dual-walled insulator in a heating apparatus is a thin-walled insulation configuration that can be difficult to manufacture, and the present invention effectively utilises a glass connecting portion to enclose the space between the inner and outer walls.

The use of glass would not be an obvious selection for use in thin-walled insulation constructions, particularly vacuum constructions, due to its brittle nature and tendency to crack. However, glass has a low heat conductivity coefficient and will prevent heat from the inner wall (and heating zone) from conducting to the outer wall of the heating apparatus. The surface area between the glass connecting piece and the inner wall should be as small as possible to further limit thermal conduction/heat loss. The glass connecting portion therefore acts as a “thermal bridge” between the inner wall and the outer wall, where known insulator heating apparatuses use a metal connecting portion. Advantageously this improves the effectiveness of the device at reducing heat transport to the outer wall and the fingers of a user. In addition glass is electrically non-conductive and acts as an electrical insulator for arrangements where the inner wall comprises a metal or metallic material.

Preferably, a vacuum is enclosed between the inner wall and the outer wall, or an insulating material is provided between the inner wall and the outer wall. In this way, the space (or insulating space) between the inner and outer walls can effectively prevent heat transfer away from the heating zone defined by the inner wall (i.e. in which an aerosol forming substance is received and heated). Examples of insulating materials which can be provided between the inner and outer walls include, but are not limited to: air, aerogel materials, powders or fibrous insulating materials. It should also be appreciated that if an insulating material is provided between the inner and outer walls the space between the inner and outer walls may not necessarily be enclosed. For example the at least one electrical insulator component may comprise one or more holes which allow air to flow through the at least one electrical insulator component (i.e. in or out of the insulating space between the inner and outer walls).

Preferably, the glass connecting portion is laser-welded to the inner wall. In this way, a highly precise laser welding technique ensures that bond between the inner wall and the glass connecting portion can be made. Preferably, the outer wall is made of glass and is a singular piece with the glass connecting portion. In this way the outer wall can be directly connected to the inner wall, and only a single connection between the outer wall and inner wall is required, thereby further improving the ease of manufacturing.

In some embodiments the outer wall comprises a metallic material, and a first end of the outer wall may be laser-welded to the glass connecting portion. In this way, both the inner wall and the outer wall may be made from a metallic material for ease of manufacturing. The inner wall may comprise a metallic material to improve thermal conduction from the heater to a received aerosol generating substance/consumable in the heating zone. As will be appreciated, the use of a metallic outer wall requires the glass connecting portion to also be connected to the outer wall by use of a glass to metal bonding technique. Advantageously laser welding ensures a particularly effective bond between the two surfaces, requiring a low surface area for bonding. Other glass to metal joining techniques may be used, as would be understood by the skilled person. Preferably, the heating apparatus further comprises a glass base, wherein a second end of the outer wall is laser-welded to the glass base. Where the outer wall comprises a metallic material, the glass base may provide further thermal insulation to the inner wall at the end opposite to the opening of the inner wall. As will be explained below, the inner wall may be part of a heater cup or a heater sleeve.

Preferably, the heating apparatus further comprises a heater cup, the heater cup comprising the inner wall and an end to limit a depth of insertion for the received aerosol forming substance. In this way, the heater cup is connected to the outer wall by a single glass connecting portion arranged at or toward the opening of the heater cup.

In some embodiments the heating apparatus further comprises a heater sleeve and a second glass connecting portion, the heater sleeve comprising the inner wall. In these arrangements the first glass connecting portion can connect a first end of the inner wall with a first end of the outer wall and the second glass connecting portion can connect a second end of the inner wall with a second end of the outer wall. In this way, glass connecting portions are provided at each end of the heater sleeve to limit thermal conduction away from the inner wall/heater sleeve. A heater sleeve allows airflow through the sleeve such that generated aerosol can be carried by an airflow to the user on inhalation.

Preferably, the heater is provided between the inner wall and the outer wall. In other words, the heater may be provided in the insulating space between the inner and outer walls. Preferably, the heater is provided within the vacuum. Preferably, the heater comprises an electrically resistive track that is printed or coated on or wrapped around an outer surface of the inner wall. In this way, the heater can effectively transfer heat to an aerosol generating substance received in the inner wall by thermal conduction. A printed or coated heater can also ensure a reliable electrical contact with the inner wall. Moreover, the ease of manufacturing may be further improved. Alternatively, the heater may comprise a separate heater track, such as a thin film heater, that is wrapped around the inner wall. To put it in another way, the heater may comprise a thin film heater having an electrically conductive metallic track that is interposed between insulating layers, such as polyimide films.

Preferably, the heating apparatus further comprises one or more wires configured to connect the heater to a power source that can supply electrical power to the heater. Preferably, the heating apparatus further comprises a thermocouple cable and/or thermistor wire configured to connect the heater to a control circuit. In this way, the temperature of the heater can be monitored and/or controlled by a control circuit.

Preferably, the one or more wires and/or the thermocouple and/or thermistor wire is moulded within glass so as to connect the heater to the power source and/or the control circuit respectively. In this way, the glass base (or the base portion of a glass outer wall) has wires and/or thermocouples premoulded into the glass to be connected to the heater. Moulding the electrical wires and/or thermocouple/thermistor wire into the glass can protect the integrity of the vacuum or insulating space between the inner and outer walls by sealing the wires/thermocouple/thermistor into the glass. Alternatively, the one or more wires may be positioned through one or more gaps provided on a longitudinal face of the outer wall. In this way, manufacturability of the heating apparatus can be simplified. In addition the wires can have a lower mass, which can be advantageous in terms of reducing the thermal mass of the device. One or more seals may be provided in the gaps to prevent air from entering the vacuum/insulating space and to secure the wires in place.

According to another aspect of the invention, there is provided an aerosol generating device configured to generate an aerosol for inhalation by a user, the aerosol generating device comprising the heating apparatus according to the first aspect of the invention.

According to another aspect of the invention, there is provided a method of manufacturing the heating apparatus according to the first aspect of the invention, the method comprising the steps of: providing an inner wall to define a heating zone and an opening through which an aerosol forming substance can be received in the heating zone; arranging a heater on the inner wall; providing an outer wall radially outwardly with respect to the inner wall; and connecting the inner wall to the outer wall with a glass connecting portion.

### BRIEF DESCRIPTION OF DRAWINGS

Embodiments of the invention are now described, by way of example, with reference to the drawings, in which:

FIG. 1 is a perspective view of an aerosol generating device comprising a heating apparatus according to an embodiment of the invention;

FIG. 2 is a cross-sectional schematic view of a heating apparatus according to an embodiment of the invention;

FIG. 3 is a cross-sectional schematic view of a heating apparatus according to another embodiment of the invention;

FIG. 4 is a cross-sectional schematic view of a heating apparatus according to another embodiment of the invention; and

FIG. 5 is a cross-sectional schematic view of a heating apparatus according to yet another embodiment of the invention.

### DETAILED DESCRIPTION

As described herein, a vapour is generally understood to refer to a substance in the gas phase at a temperature lower than its critical temperature, which means that the vapour can be condensed to a liquid by increasing its pressure without reducing the temperature, whereas an aerosol is a suspension of fine solid particles or liquid droplets, in air or another gas. It should, however, be noted that the terms ‘aerosol’ and ‘vapour’ may be used interchangeably in this specification, particularly with regard to the form of the inhalable medium that is generated for inhalation by a user.

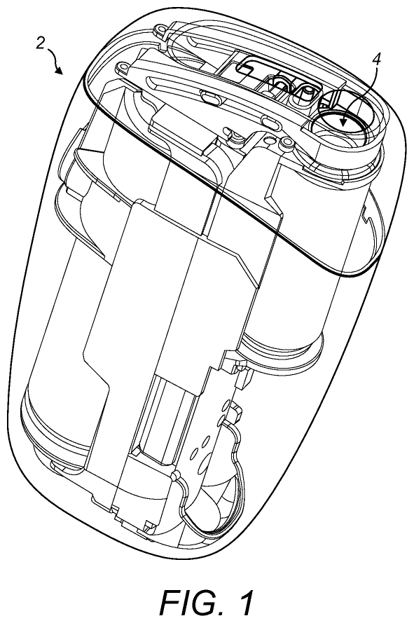

FIG. 1 illustrates an aerosol generating device 2 according to an embodiment of the invention. The aerosol generating device 2 is illustrated in an assembled configuration with exemplary internal components visible. The aerosol generating device 2 is a heat-not-burn device, which may also be referred to as a tobacco-vapour device, and comprises a heating apparatus 4 configured to receive an aerosol substrate such as a rod of aerosol generating material, e.g. tobacco. The aerosol generating device 2 may comprise a power source such as a battery and control circuitry for controlling the supply of power from the power source to the heating apparatus 4. The heating apparatus 4 is operable to heat, but not burn, the rod of aerosol generating material to produce a vapour or aerosol for inhalation by a user. Of course, the skilled person will appreciate that the aerosol generating device 2 depicted in FIG. 1 is simply an exemplary aerosol generating device according to the invention. Other types and configurations of tobacco-vapour products, vaporisers, or electronic cigarettes may also be used as the aerosol generating device according to the invention.

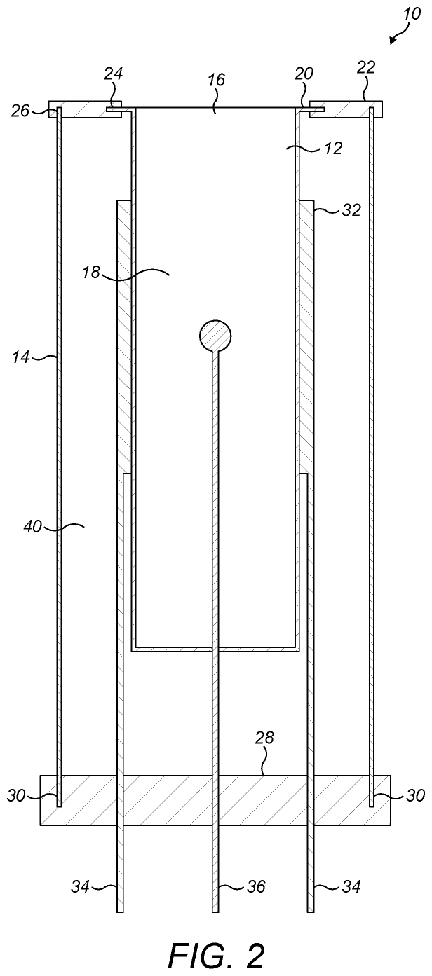

The specific examples below in reference to FIGS. 2, 3, 4 and 5 have been described with a vacuum enclosed between the inner and outer walls of the heating apparatus. However, it will be appreciated that the vacuum may be replaced with other insulating mediums/materials, such as air, aerogel materials, powders or fibrous insulating materials which may be provided between the inner and outer tubes of the heating apparatus. In such examples (where a vacuum is replaced with an insulating material), the space between the inner and outer walls may not be enclosed and may allow airflow in and out of the space. FIG. 2 shows a schematic view of a heating apparatus 10 having a heater cup 12 and an outer tube 14. The heater cup 12 comprises the inner wall of the heating apparatus 10, which defines an opening 16 through which an aerosol forming substance, or consumable, can be received in a heating zone 18 of the heating apparatus 10. The heater cup 12 comprises a metallic material, such as stainless steel, which has good thermal conduction properties. The opening 16 acts as the access point for insertion of a consumable into the heating apparatus 10 in its constructed form. The heater cup 12 is closed at its base to limit the depth of insertion of a consumable. The outer tube 14 comprises a metallic material, such as steel or stainless steel, which is readily formed into a tube or cylindrical shape.

The inner heater cup 12 is positioned radially within the inner surface of the outer tube 14 as concentric cylinders such that if viewed from above or below, i.e. parallel to a longitudinal axis of the heater cup and the outer tube will show the cup and tube as concentric circles (not shown). In alternative examples, the heater cup 12 and/or outer tube 14 may be formed in other types of cross-sectional shape, such as a square or polygonal.

The heater cup 12 has a lip 20 at its open end. The lip 20 points outwardly toward the outer tube 14. The inner edge of a ring-shaped upper glass connecting portion 22 is laser-welded to the lip 20 to form a glass-metal seal 24 (or glass-metal joint). The outer edge of the upper glass connecting portion 22 is laser-welded to the top end of the outer tube 14 to form a second glass-metal seal 26. In this particular example, the wall thickness at the top end of the outer tube 14 is reduced (relative to the main length of the outer tube 14) to allow the second glass-metal seal to bond more effectively.

It should be appreciated that the heater cup lip 20 and the top end of the outer tube 14 having a thinner wall thickness are not necessary to form glass-metal seals. For example the upper glass connecting portion 22 may be connected to the upper edge of the end of the heater cup (e.g. an open end of a cup with no lip), and the wall of the outer tube 14 may have a constant wall thickness. In another example the end of the outer tube 14 may be folded or bent such that it is perpendicular to the main length of the outer tube 14 to form the laser-welded seal. In addition other glass-metal sealing techniques to form a thin glass to metal seal would be apparent to the skilled person.

The top end of the outer tube 14 is positioned substantially in line with the open end of the heater cup 12, and the outer tube 14 has a length which extends beyond the length of the heater cup 12. A disc-shaped lower glass connecting portion 28, i.e. a glass base, is laser-welded to the bottom end of the outer tube 14 to form a third glass-metal seal 30. Similar to the second glass-metal seal 26 the bottom end of the outer tube 14 has a reduced wall-thickness. Other suitable glass to metal bonding techniques and different designs for the third glass-metal seal 30 will be readily apparent to the skilled person.

The upper and lower glass connecting portions 22, 28 enclose the space between the outer surface of the heater cup 12 and the inner surface of the outer tube 14 in order for a vacuum 40 to be enclosed. The skilled person will understand that the term “vacuum” refers to a space in which the pressure is considerably lower than atmospheric pressure due to the removal of free matter, in particular air. The quality of the vacuum 40 formed between the inner tube 12 and the outer tube 14 may be a low vacuum, a medium vacuum, or a high vacuum. As explained above, the vacuum 40 may be replaced with other insulating mediums/materials to fill the space between the outer surface of the heater cup 12 and the inner surface of the outer tube 14.

A heater 32 is provided on the outer surface of the heater cup 12 (i.e. such that the heater is provided in the vacuum 40). The heater 32 is an electrically resistive track that may be printed or coated on the heater cup 12. Alternatively, the heater 22 may be layered on the heater cup 12. Electrical wires 34 connects the heater 32 to a power source or a printed circuit board assembly, PCBA (not shown). The heating apparatus 10 also optionally comprises a thermocouple or thermistor wire 36 which is connected to the PCBA to monitor and/or control the temperature of the heater 32.

The electrical wires 34 and the thermocouple/thermistor wire 36 are moulded into the lower glass connecting portion 28. Other techniques (such as holes and suitable seals) may be used to pass the wires 34, 36 through the lower glass connecting portion 28 that will be apparent to the skilled person.

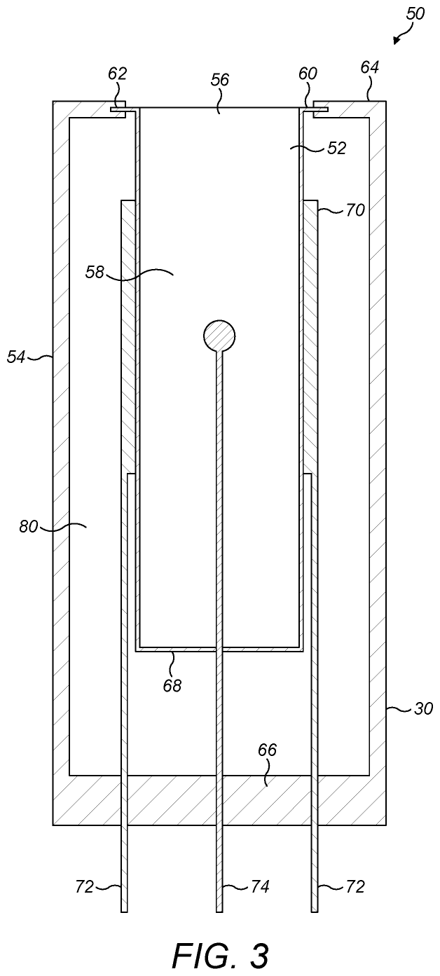

FIG. 3 shows another schematic view of a heating apparatus 50 having a heater cup 52 and an outer cup 54. Similar to the heating apparatus 10 of FIG. 2, the heater cup 52 comprises the inner wall of the heating apparatus 50, which defines an opening 56 through which a consumable, can be received in a heating zone 58 of the heating apparatus 50. The opening 56 acts as the access point for insertion of a consumable into the heating apparatus 50 in its constructed form, and the heater cup 52 comprises a metallic material which has good thermal conduction properties. The heater cup 52 is closed at its lower end to limit the depth of insertion of a consumable.

The outer cup 54 comprises glass, and is shaped to surround the entire outer surface of the heater cup 52, and to space apart the outer surface of the heater cup 52 and the inner surface of the outer cup 54.

At the open end of the heater cup 52, the cup has a lip 60 that forms a glass-metal seal 62 with a glass connecting portion 64 of the outer cup 54. In this example, the glass connecting portion 64 and the glass outer cup 54 are moulded as a singular piece of glass. However it should be apparent that multiple pieces of glass may be used (and bonded together). The glass-metal seal 62 is formed by laser welding or any other suitable technique for forming thin glass to metal joints. By forming the glass-metal seal 62 between the glass connecting portion 64 of the glass outer cup 54 and the lip 60 of the inner heater cup 52, a vacuum 80 (or other insulating mediums/materials) can be enclosed between the outer surface of the heater cup 52 and the inner surface of the outer cup 54. The quality of the vacuum 80 formed between the inner tube 12 and the outer tube 14 may be a low vacuum, a medium vacuum, or a high vacuum.

As will be appreciated the glass base 66 of the outer cup 54 is also part of the same singular piece of glass as the outer cup 54 and is spaced apart from the closed end 68 of the heater cup 52 (the closed end 68 limits the insertion of a consumable in the heater cup 52).

Similar to the heating apparatus 10 of FIG. 2, a heater 70 is arranged on the outer surface of the heater cup 52 in the vacuum between the heater cup 52 and the outer cup 54. The heater 70 is an electrically resistive track that may be printed or coated on the heater cup 52. Alternatively, the heater 70 may be layered on the heater cup 52. Electrical wires 72 connects the heater 70 to a power source or a printed circuit board assembly, PCBA (not shown). The heating apparatus 50 also optionally comprises a thermocouple or thermistor wire 74 which 70 connected to the PCBA to monitor and/or control the temperature of the heater 32.

The electrical wires 72 and the thermocouple/thermistor wire 74 are moulded into the glass base 66 of the glass outer cup 54, although it will be appreciated that other techniques (such as holes and suitable seals) may be used to pass the wires 72, 74 through the glass base 66 will be apparent to the skilled person.

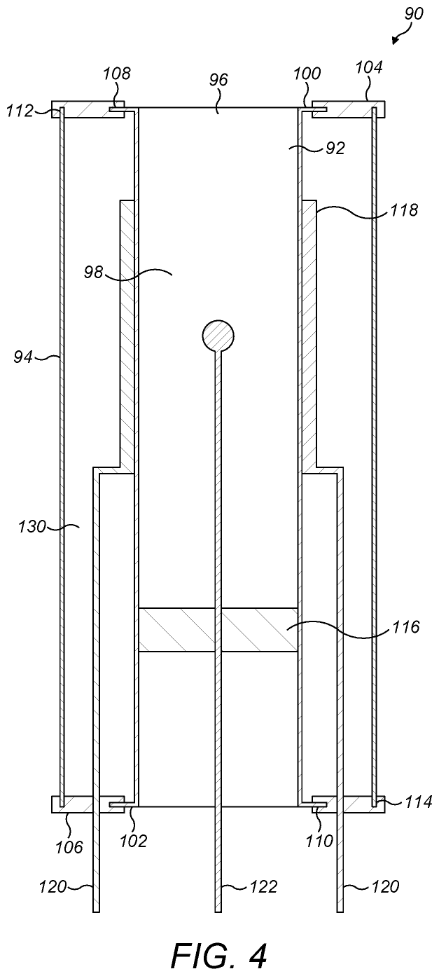

FIG. 4 shows another schematic view of a heating apparatus 90 having an inner heater tube 92 and an outer tube 94. The heater tube 92, or heater sleeve, comprises the inner wall of the heating apparatus 90, which defines an opening 96 through which a consumable, can be received in a heating zone 98 of the heating apparatus 90. The opening 96 acts as the access point for insertion of a consumable into the heating apparatus 90 in its constructed form, and the heater tube/sleeve 92 comprises a metallic material which has good thermal conduction properties.

The outer tube 94 comprises a metallic material, such as steel or stainless steel, which is readily formed into a tube or cylindrical shape. The inner heater tube 92 is positioned radially within the inner surface of the outer tube 94 as concentric cylinders such that if viewed from above or below, i.e. parallel to a longitudinal axis of the heater tube 92 and the outer tube 94 will show the cup and tube as concentric circles (not shown). In alternative examples, the heater tube 92 and/or outer tube 94 may be formed in other types of cross-sectional shape, such as a square or polygonal.

The heater tube 92 has a top lip 100 and a bottom lip 102 at the top and bottom ends of the tube 92 respectively. The top and bottom lips 100, 102 point outwardly toward the outer tube 94, and a ring-shaped upper glass connecting portion 104 and a ring-shaped lower glass connecting portion 106 are laser-welded to the edges of the top and bottom lips 100, 102 respectively to form an upper glass-metal seal 108 and a lower glass-metal seal 110 respectively. Other suitable glass to metal bonding techniques may be used.

The top and bottom ends of the metallic outer tube 94 are laser-welded (or otherwise bonded) to the upper glass connecting portion/ring 104 and the lower glass connection/ring 106 respectively in a similar way to that described in reference to the outer tube 14 in the heating apparatus 10 of FIG. 2 to form a second upper glass-metal seal 112 between the outer tube 94 and the upper glass ring 104 and a second lower glass-metal seal 114 between the outer tube 94 and the lower glass ring 106. It will be appreciated that the wall thickness of the ends of the outer tube 94 may be thinner relative to the main length of the outer tube 94 to ensure an effective glass-metal join from the laser welding process. Other configurations of the glass-metal seals 108, 110, 112, 114 would be apparent to the skilled person.

The upper and lower glass rings 104, 106 enclose the space between the outer surface of the heater tube 92 and the inner surface of the outer tube 94 in order for a vacuum 130 (or other insulating materials) to be enclosed. The quality of the vacuum 130 formed between the inner tube 92 and the outer tube 94 may be a low vacuum, a medium vacuum, or a high vacuum.

The heater tube 92 further optionally comprises a plug 116 positioned within the heater tube 92 to act as an abutment for an inserted consumable. The plug 116 may be ring-shaped or have apertures to allow airflow across the plug 116, or alternatively may be a solid block to prevent airflow.

The heating apparatus 90 includes a heater 118 and wires 120, 122 similar to those described with reference to the above heating apparatuses 10, 50 of FIGS. 2 and 3. The wires 120, 122 may be moulded within the lower glass ring 104, or alternatively may pass through one or more holes in the wall of the inner heater tube 92 (below the plug 114, if present) with seals as appropriate to maintain the vacuum 130.

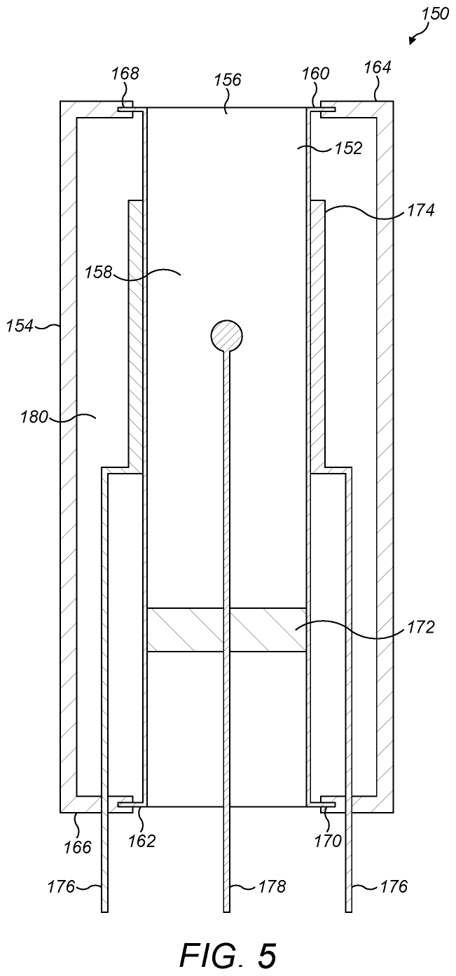

FIG. 5 shows another schematic view of a heating apparatus 150 having an inner heater tube 152 and an outer tube 154. The heater tube/sleeve 152, similar to the heater sleeve 92 of FIG. 4, comprises the inner wall of the heating apparatus 150, which defines an opening 156 through which a consumable, can be received in a heating zone 158 of the heating apparatus 150.

The heater tube/sleeve 152 comprises a metallic material which has good thermal conduction properties, and has a top lip 160 and a bottom lip 162 at the top and bottom ends of the tube 152 respectively. The top and bottom lips 160, 162 point outwardly toward the outer tube 154.

The outer tube 154 comprises glass cylinder having a ring-shaped upper glass connecting portion 164 and a ring-shaped lower glass connecting portion 166 at the top and bottom ends of the cylinder to form a single piece of glass. In another example, the glass rings 164, 166 can be bonded onto the glass cylinder.

The upper and lower glass connecting portions/rings 164, 166 are laser-welded to the edges of the top and bottom lips 160, 162 respectively to form an upper glass-metal seal 168 and a lower glass-metal seal 170 respectively. Other suitable glass to metal bonding techniques may be used and other configurations of the glass-metal seals 168, 170 would be apparent to the skilled person.

The upper and lower glass rings 164, 166 enclose the space between the outer surface of the heater tube 152 and the inner surface of the outer tube 154 in order for a vacuum 180 (or other insulating materials) to be enclosed. The quality of the vacuum 180 formed between the inner tube 152 and the outer tube 154 may be a low vacuum, a medium vacuum, or a high vacuum.

The heater tube 152 further optionally comprises a plug 172 positioned within the heater tube 152 to act as an abutment for an inserted consumable. The plug 172 may be ring-shaped or have apertures to allow airflow across the plug 172, or alternatively may be a solid block to prevent airflow.

The heating apparatus 150 includes a heater 174 and wires 176, 178 similar to those described with reference to the above heating apparatuses 10, 50, 90 of FIGS. 2, 3 and 4. The wires 176, 178 may be moulded within the lower glass ring 166, or alternatively may pass through one or more holes in the wall of the inner heater tube 152 (below the plug 172, if present) with seals as appropriate to maintain the vacuum 180.

1. A heating apparatus for an aerosol generating device, comprising:
an inner wall defining a heating zone and an opening through which an aerosol forming substance can be received in the heating zone;
a heater arranged on the inner wall and configured to provide heat to an aerosol forming substance that is received in the heating zone;
an outer wall positioned radially outwardly with respect to the inner wall; and
a glass connecting portion connecting the inner wall and the outer wall.

2. The heating apparatus of claim 1, wherein a vacuum is enclosed between the inner wall and the outer wall, or wherein an insulating material is provided between the inner wall and the outer wall.

3. The heating apparatus of claim 1, wherein the glass connecting portion is laser-welded to the inner wall.

4. The heating apparatus of claim 1, wherein the outer wall is made of glass and is a singular piece with the glass connecting portion.

5. The heating apparatus of claim 1, wherein the outer wall comprises a metallic material, and wherein a first end of the outer wall is laser-welded to the glass connecting portion.

6. The heating apparatus of claim 5, further comprising a glass base, wherein a second end of the outer wall is laser-welded to the glass base.

7. The heating apparatus of claim 1, further comprising a heater cup, the heater cup comprising the inner wall and an end to limit a depth of insertion for the received aerosol forming substance.

8. The heating apparatus of claim 1, further comprising a heater sleeve comprising the inner wall, wherein the glass connecting portion connects a first end of the inner wall with a first end of the outer wall, and further comprising a second glass connecting portion that connects a second end of the inner wall with a second end of the outer wall.

9. The heating apparatus of claim 1, wherein the heater is provided between the inner wall and the outer wall.

10. The heating apparatus of claim 1, wherein the heater comprises an electrically resistive track that is printed or coated on or wrapped around the inner wall.

11. The heating apparatus of claim 1, further comprising one or more wires configured to connect the heater to a power source that can supply electrical power to the heater.

12. The heating apparatus of claim 1, further comprising a thermocouple cable and/or thermistor wire configured to connect the heater to a control circuit.

13. (canceled)

14. An aerosol generating device configured to generate an aerosol for inhalation by a user, the aerosol generating device comprising the heating apparatus according to claim 1.

15. A method of manufacturing a heating apparatus for an aerosol generating device, the method comprising the steps of:
providing an inner wall to define a heating zone and an opening through which an aerosol forming substance can be received in the heating zone;
arranging a heater on the inner wall;
providing an outer wall radially outwardly with respect to the inner wall; and
connecting the inner wall to the outer wall with a glass connecting portion.

16. The heating apparatus of claim 11, wherein the one or more wires is moulded within glass so as to be configured to connect the heater to the power source.

17. The heating apparatus of claim 12, wherein the thermocouple cable and/or thermistor wire is moulded within glass so as to be configured to connect the heater to the control circuit.
